(19) United States
(12) Patent Application Publication
(10) Pub. No.: US 2009/0232292 A1
(43) Pub. Date: Sep. 17, 2009

(54) METHODS FOR PROVIDING EVENT NOTIFICATION

(76) Inventors: Aaron Baalbergen, Miami, FL (US); Demian Martin, San Leandro, CA (US)

Correspondence Address: IPSG, P.C., P.O. BOX 700640, SAN JOSE, CA, 95170, US

(21) Appl. No.: 12/046,399

(22) Filed: Mar. 11, 2008

(51) Int. Cl. H04M 3/42

(52) U.S. Cl. 379/207.02

(57) ABSTRACT

A method for providing notification concerning an event to at least a recipient through at least a phone is disclosed. The method may include associating the event with a calling number. The method may also include making a call to at least the phone using the calling number (e.g., originating the call from a communication device and/or a communication account associated with the calling number) if the event is detected.

### BACKGROUND OF THE INVENTION

The present invention relates to providing event notification (or event alerts). In particular, the invention may relate to informing users about the occurrence of events utilizing one or more telecommunication systems, services, and/or devices. For example, the events may include one or more of a fire alarm, machine malfunction, process anomaly, home intrusion, car intrusion, person excursion, pet excursion, etc.

Given the prevalence of mobile phones, notification methods have been implemented utilizing monitoring systems to automatically send alerts to mobile phones when events are detected. The alert may typically represent, for example, a text message, an email message, or a voice call/message.

The conventional notification methods may have several disadvantages. For example, the intended recipient of an event alert may need to perform multiple keystrokes or button pushes to access a text, email, or voice message inbox before the recipient can view or listen to the alert. Accordingly, substantial delay may be involved. Further, if the recipient is engaged in a phone call, i.e., if the terminating/receiving mobile phone utilized by the recipient is busy, the arrival of the alert may not be timely indicated until the recipient has finished the call. The recipient may be unaware of the existence of the alert until the phone call has been finished. As a result, the recipient may not be able to timely respond to the event. If the event represents a matter of urgency, significant loss may be incurred in the absence of a timely response.

### SUMMARY OF INVENTION

An embodiment of the invention relates to a method for providing notification concerning an event to at least a recipient through at least a phone. The method may include associating the event with a calling number. The method may also include making a call to at least the phone using the calling number (e.g., originating the call from a communication device and/or a communication account associated with the calling number) if the event is detected.

The above summary relates to only one of the many embodiments of the invention disclosed herein and is not intended to limit the scope of the invention, which is set forth in the claims herein. These and other features of the present invention will be described in more detail below in the detailed description of the invention and in conjunction with the following figures.

### BRIEF DESCRIPTION OF THE DRAWINGS

The present invention is illustrated by way of example, and not by way of limitation, in the figures of the accompanying drawings and in which like reference numerals refer to similar elements and in which;

FIG. 1 shows a schematic representation illustrating a numbering scheme for providing event notification in accordance with one or more embodiments of the present invention.

FIG. 2A shows a flowchart illustrating a method for providing event notification in accordance with one or more embodiments of the present invention.

FIG. 2B shows a flowchart illustrating a method for making a phone call to provide event notification in accordance with one or more embodiments of the present invention.

### DETAILED DESCRIPTION OF EMBODIMENTS

The present invention will now be described in detail with reference to a few embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention.

Various embodiments are described herein below, including methods and techniques. It should be kept in mind that the invention might also cover articles of manufacture that includes a computer readable medium on which computer-readable instructions for earning out embodiments of the inventive technique are stored. The computer readable medium may include, for example, semiconductor, magnetic, opto-magnetic, optical, or other forms of computer readable medium for storing computer readable code. Further, the invention may also cover apparatuses for practicing embodiments of the invention. Such apparatus may include circuits, dedicated and/or programmable, to carry out tasks pertaining to embodiments of the invention. Examples of such apparatus include a general-purpose computer and/or a dedicated computing device when appropriately programmed and may include a combination of a computer/computing device and dedicated programmable circuits adapted for the various tasks pertaining to embodiments of the invention.

One or more embodiments of the present invention relate to a method for providing event notification utilizing one or more telecommunication systems, services, and/or devices. The method may take advantage of the caller identification (or calling number identification) sendee and/or the call waiting service, which may be provided by one or more telecommunication service providers, to deliver event alerts. The method may include utilising various calling numbers to represent various events. The method may also include making phone calls to appropriate recipients with appropriate calling numbers if the events represented by the calling numbers are detected. For example, the phone calls may be originated from one or more communication devices and/or communication accounts associated with the appropriate calling numbers. Given the caller identification service, the phones that receive fee phone calls may automatically display the event alerts (represented by the calling numbers or event descriptions resulted from translating/decoding the calling numbers) without requiring the recipients to perform any keystrokes or button pushes. Further, given the call waiting sendee, the event alerts may be promptly displayed by the phones and timely viewed by fee recipients even if the recipients are engaged in phone calls. Advantageously, the recipients may be able to timely respond to the events.

The features and advantages of the invention may be better understood with reference to the figures and discussions that follow.

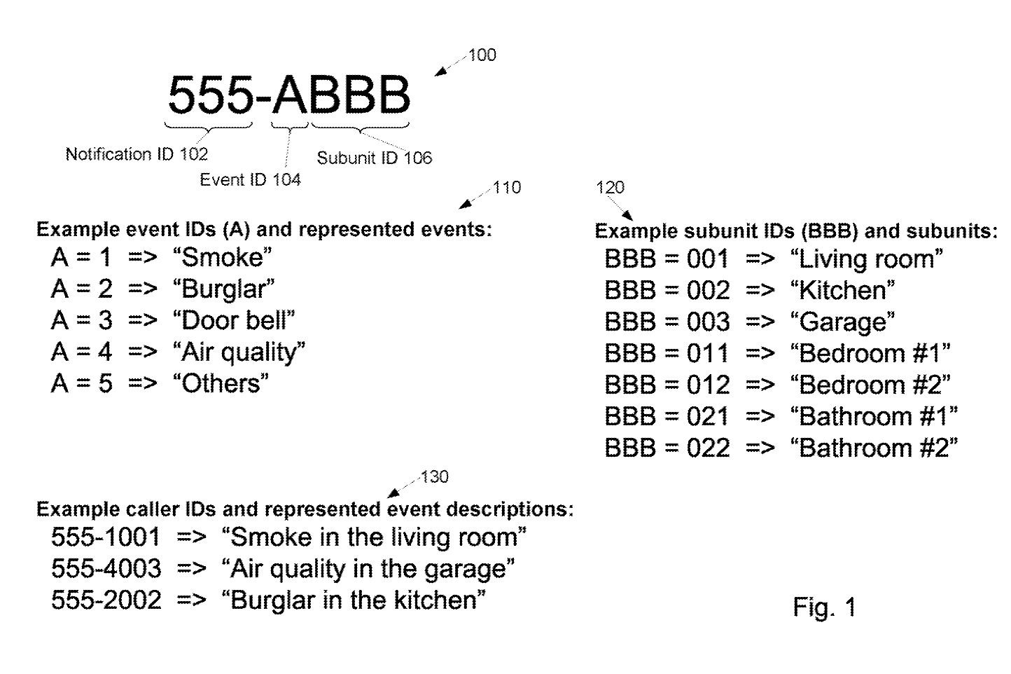

FIG. 1 shows a schematic representation illustrating a numbering scheme for providing event notification in accordance with one or more embodiments of the present invention. In one or more embodiments, a plurality (e.g., a block) of calling numbers may be reserved, e.g. from a telecommunication service provider, for representing events. In the example of FIG. 1, calling number format 100 may illustrate the numbering scheme for the plurality of calling numbers.

Calling number format 100 may include a set of identification sections, such as one or more of alert identification section 102, event identification section 104, and subunit identification section 106.

Alert identification section 102 may identify calling numbers according to calling number format 100 as event alerts. A value may be reserved for alert identification section 102 for the identification purpose without being utilized for other purposes. The value is illustrated by “555” in this example.

Event identification section 104 may represent one or more event types and may be utilized for identifying/indicating different event types. As illustrated in the example of association table 110, a set of event-type values for event identification section 104 may be associated with a set of event types for indicating the event types. For example, the event-type values “1,” “2,” “3,” “4,” and “5” may be utilized for indicating the event types “smoke,” “burglar,” “door bell,” “air quality,” and “others,” respectively.

Subunit identification section 106 may represent one or more subunits of a unit and may be utilized for identifying/indicating different subunits. For example, the different subunits may represent different locations in a budding, different branches (e.g., departments, offices, and/or stores) of an organization, different parts of a device, different parts of a body, different devices in a system, different people in a group, and/or different animals in an animal group. As illustrated in the example of association table 120, a set of subunit values for subunit identification section 106 may be associated with a set of subunit identifiers for indicating the subunits. For example, the subunit values “001,” “002,” “003,” “011,” “012,” “021,” and “022” may be utilized for indicating the locations “living room,” “kitchen,” “garage,” “bedroom #1,” “bedroom #2,” “bathroom #1,” and “bathroom #2,” respectively, in a house.

In one or more embodiments, one or more other identification sections for other event information may be included in calling number format 100.

According to the values of alert identification section 102, event identification section 104, subunit identification section 106, and/or, if applicable, one or more other identification sections, the event alert represented by a calling number may be properly decoded or translated, for example, based on table 110, table 120, and/or one or more other association tables. As illustrated in the example of table 130, the calling numbers “555-1001,” “555-4003,” and “555-2002” may represent (and may be decoded/translated to) fee event descriptions “smoke in the living room,” “air quality in the garage,” and “burglar in the kitchen,” respectively.

The decoding or translation may be performed, e.g., mentally, by the recipient of fee call when the recipient sees the calling number. To perform the decoding or translation, the recipient may have been informed in advance of the value or values for alert identification section 102, various event-type values and associated event types, and various subunit values and associated subunit identifiers.

Alternatively or additionally, the decoding or translation may be automatically performed by the terminating/receiving phone of the call and/or by a caller identification device coupled with the phone. For example, a software application may be implemented in the phone or the caller identification device for performing the decoding or translation. As another example, a service provider or the recipient may program a phonebook entry stored in the phone such that the phonebook entry includes the calling number and the associated event description. Accordingly, the phone may display fee event description instead of the calling number when the phone receives the call.

Taking advantage of the calling identification service, the phone may automatically and promptly display the calling number or event description without requiring the recipient to perform any keystrokes or button bushes on the phone. Further, given the call waiting service, the calling number or event description may be displayed even if the phone is busy. Advantageously, the event notification may be viewed by the recipient with minimum delay, and the recipient may be able to timely respond to the event.

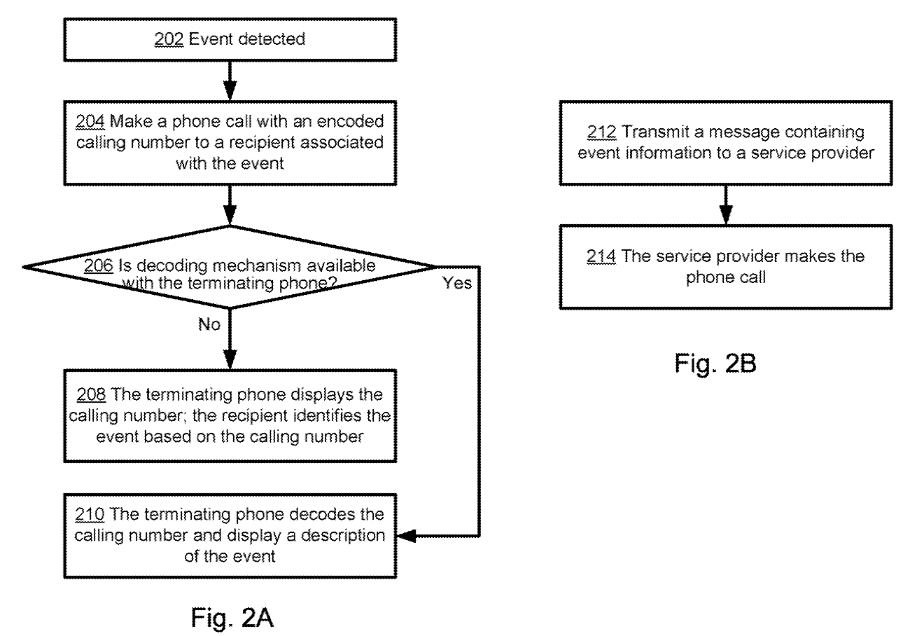

FIG. 2A shows a flowchart illustrating a method for providing event notification in accordance with one or more embodiments of fee present invention. The method may start with step 202, in which a monitoring system may detect the occurrence of an event, such as one of the events described in the example of table 130 illustrated in the example of FIG. 1.

In step 204, a phone call with an appropriate calling number (e.g., an encoded/meaningful calling number for event notification as illustrated in the example of FIG. 1) may be made to an appropriate recipient (or fee phone/identification number associated wife fee recipient); the calling number may represent an alert and/or description of fee detected event. The call (or one or more other calls utilizing fee calling number) may also be made to one or more other recipients associated with the event.

The recipient(s) or phone/identification numbers associated with the recipient(s) may be selected based on the value(s) of one or more identification sections of the calling number. For example, the recipient(s) may be selected based on the type and/or the location associated with the occurrence of the event. As an example, if smoke is detected in Store #1 located in City A, the recipient(s) may represent Manager #1 of Store #1 and/or the fire department of City A; if burglar is detected in Store #2 located in City B, the recipient(s) may represent Manger #2 of Store #2 and/or the police department of City B. The monitoring system may automatically perform the selection according to a set of predefined rules.

The phone call may be originated from the monitoring system. Alternatively, the phone call may be originated from a service provider, as further discussed below with reference to the example of FIG. 2B. In one or more embodiments, a communication action may be initialed utilizing an originating number that is different from the calling number, and the originating number may be masked utilizing the calling number to produce the phone call.

In step 206, the terminating/receiving phone of the phone call may determine whether a decoding mechanism is available in the phone and/or, if applicable, a caller identification device coupled with the phone. If no decoding mechanisms are available, control may be transferred to step 208; if a decoding mechanism is available, control may be transferred to step 210.

In step 208, the phone may display the calling number. Upon seeing the calling number, the recipient may identify the calling number as an event alert and may determine one or more characteristics of the event based on the values of one or more identification sections of the calling number.

In step 210, the phone (and/or the caller identification device) may decode or translate the calling number to display a description of the event.

Based on the information obtained from step 208 or step 210, the recipient may be able to timely respond to the event.

FIG. 2B shows a flowchart illustrating a method for making a phone call to provide event notification in accordance with one or more embodiments of the present invention. The method may represent one or more embodiments of step 204 illustrated in the example of FIG. 2A. The method may start with step 212, in which the monitoring system may transmit a message that contains information concerning the event and selected recipient(s) to a service provider. In step 214, the service provider may make the phone call to the selected recipient(s).

According to the arrangement of originating the call from the service provider, special calling numbers reserved for providing event notification may be shared by different monitoring systems. As a result, the users of the monitoring systems may not need to individually have access to the special calling numbers, and the users may not need to individually reserve different sets of special numbers. Advantageously, fee implementation costs for the monitoring systems may be reduced, and the number resource may be conserved.

As can be appreciated from the foregoing, embodiments of the invention may deliver event alerts as encoded, meaningful calling numbers, taking advantage of the caller identification service. According, the intended recipients of the event alerts may be able to promptly view the alerts without performing any keystrokes. Further, given the call waiting service, the recipients may timely view the alerts even if the recipients are engaged in phone calls. Advantageously, the recipients may timely respond to the events with minimum delay.

While this invention has been described in terms of several embodiments, there are alterations, permutations, and equivalents, which fall within the scope of this invention, it should also be noted that there are many alternative ways of implementing the methods and apparatuses of the present invention. Furthermore, embodiments of the present invention may find utility in other applications. The abstract section is provided herein for convenience and, due to word count limitation, is accordingly written for reading convenience and should not be employed to limit the scope of the claims. It is therefore intended that the following appended claims be interpreted as including all such alterations, permutations, and equivalents as fall within the true spirit and scope of the present invention.

What is claimed is:

1. A method for providing notification concerning an event to at least a recipient through at least a phone, the method comprising:
associating the event with a calling number; and
making a call to at least the phone using the calling number if the event is detected.

2. The method of claim 1 further comprising presenting the calling number using at least one of the phone and a caller identification device coupled with the phone.

3. The method of claim 1 further comprising:
translating the calling number to a description concerning the event; and
presenting the description using the phone.

4. The method of claim 3 further comprising implementing a mechanism in the phone for performing the translating.

5. The method of claim 3 further comprising displaying the description on the phone even if the phone is busy.

6. The method of claim 1 further comprising:
transmitting a message concerning the event to a service provider;
selecting the calling number and the recipient according to the message; and
originating the call from the service provider to the recipient using the calling number.

7. The method of claim 1 wherein the making the call includes
initiating a communication action using an originating number different from the calling number, and
masking the originating number using the calling number to produce the call.

8. The method of claim 1 further comprising:
allocating a section of the calling number for identifying the calling number as an event alert; and
assigning a value designated for the identifying for the section of the calling number.

9. The method of claim 8 further composing informing the recipient of at least the value prior to the making the call.

10. The method of claim 1 further comprising associating a value of a section of the calling number with a type of the event.

11. The method of claim 10 further comprising selecting an identification number associated with at least one of the recipient and the phone based at least in part on the value of the section of calling number.

12. The method of claim 1 further comprising associating a value of a section of the calling number with a subunit of a unit, the event concerning the subunit of the unit, wherein the subunit of the unit represents at least one of a location in a building, a branch of an organization, a part of an apparatus, a part of a body, a device in a system, a person in a group, and an animal in an animal group.

13. The method of claim 12 further comprising selecting an identification number associated with at least one of the recipient and the phone based at least in part on the value of the section of calling number.

14. The method of claim 1 further comprising originating a second call using the calling number if the event is detected, the call intended to be received by at least a second phone used by a second recipient.

15. The method of claim 1 wherein the call is made to a plurality of phones, the plurality of phones including fee phone, fee method further comprising implementing a mechanism in each of the plurality of phones for translating the calling number to a description concerning the event.

16. The method of claim 1 further comprising:
allocating a first section of each of a plurality of caller identification numbers for identifying the plurality of caller identification numbers as event alerts, the calling number being one of the plurality of caller identification numbers; and
assigning a value for the first section for the identifying.

17. The method of claim 16 further comprising:
allocating a second section of each of the plurality of caller identification numbers for representing one or more event types; and
associating a set of event-type values for the second section with a set of event types.

18. The method of claim 17 further comprising:
allocating a third section of each of the plurality of caller identification numbers for representing one or more subunits of a unit; and
associating a set of subunit values for the third section with a set of subunits of the unit,
wherein the set of subunits of the unit represents at least one of a set of locations in a building, a set of branches of an organization, a set of parts of a device, a set of devices in a system, a set of people in a group, and a set of animals in an animal group.

19. The method of claim 16 further comprising:
allocating a second section of each of the plurality of caller identification numbers for representing one or more subunits of a unit; and
associating a set of subunit values for the second section with a set of subunits of the unit,
wherein the set of subunits of the unit represents at least one of a set of locations in a building, a set of branches of an organization, a set of parts of a device, a set of devices in a system, a set of people in a group, and a set of animals in an animal group.

20. The method of claim 1 further comprising programming a phonebook entry stored in the phone for the phonebook entry to include at least the calling number and a description concerning the event.

21. The method of claim 1 further comprising originating the call from at least one of a communication device and a communication account associated with the calling number.
